(19) United States
(12) Patent Application Publication
(10) Pub. No.: US 2016/0011720 A1
(43) Pub. Date: Jan. 14, 2016

(54) Multi-Touch Interface for Blind Real-Time Interaction

(71) Applicant: Thomas Christian Walther, Berlin (DE)

(72) Inventor: Thomas Christian Walther, Berlin (DE)

(21) Appl. No.: 14/327,649

(22) Filed: Jul. 10, 2014

(51) Int. Cl. G06F 3/041; G06F 3/0488; G06F 3/01; G06F 3/0484

(52) U.S. Cl. CPC G06F 3/0418; G06F 3/04847; G06F 3/0488; G06F 3/016; G06F 2203/04808

(57) ABSTRACT

Apparatus and methods are disclosed for controlling multiple parameters on a multi-touch surface. Design of the apparatus and the multi-touch gestures enable unprecedented control of parameters by allowing the user to alter multiple parameters blindly in real-time with varying sensitivity.

### CROSS-REFERENCE TO RELATED APPLICATIONS

This application claims the benefit of the provisional patent application Ser. No. 61/845,941, filed 2013 Jul. 11 by the present inventor.

### BACKGROUND

### Prior Art

The following is a tabulation of some prior art that presently appears relevant:

U.S. Patent Application Publications

| Publication Nr. | Kind Code | Publ. Date | Applicant |
|---|---|---|---|
| U.S. Pat. No. 4,179,971 | A | Dec. 25, 1979 | Nippon Gakki Seizo Kabushiki Kaisha |
| U.S. Pat. No. 5,741,993 | A | Apr. 21, 1998 | Kabushiki Kaisha Kawai Gakki Seisakusho |

### Nonpatent Literature Documents

Korg Kaoss Pad KP2 Owner's Manual. 2002.

Korg Kaoss Pad KP3+ Website; Accessed Jul. 9, 2014.

JazzMutant Lemur Website, Accessed Jul. 9, 2014. jazzmutant.com/lemur_overview.php

Moog Minimoog Voyager XL Owner's Manual. 2010.

The present invention relates to interfaces in general, and specifically touch interfaces, that allow users to change parameters of a software or a hardware device, either integrated or attached to the embodiment, in real-time, by using touch gestures to effect commands. While it is developed with music production in mind, it is not limited to this field but can be used in any field where a user needs to change a continuous parameter blindly.

There are many interfaces for controlling parameters on a device. Such input controls can be categorized into controls that toggle a state—e.g. switches, switch pedals and buttons—and controls for altering continuous values. The latter group includes classical rotary knobs, endless rotary knobs, faders, expression pedals, distance sensors, modulation wheels, rubber bands and touch areas. This invention focuses on said latter group. Within the scope of this invention, the parameters that said latter group of interface elements controls will be called Continuous Parameters.

In the music field, keyboards traditionally provide the user a set of rotary knobs and faders to control Continuous Parameters. While these haptic controls can be used blindly as soon as the user touches them, reaching for them requires the user to look at them. Some users know the position of knobs, faders and other input devices on a machine by heart, but this requires extensive training With an increasing number of faders, knobs or similar control elements, reaching for the right control becomes more difficult. Additionally, the average distance that the hand of a user has to travel to go from one control element to another increases with more controls. Especially for real-time performances, it would be desirable for a user to be able to control these parameters blindly. Musicians may want to look at their audience while performing. Similarly, professionals in other fields may want to concentrate on something else than the input controls.

Toshiyuki Takahashi, Masahiko Koike and Haruyuki Suzuki have invented an apparatus for modulating the pitch of a musical instrument, as published in U.S. Pat. No. 4,179,971. This invention became commonly known as a “pitch bend wheel”, which is clearly depicted in FIG. 2 of US patent publication U.S. Pat. No. 5,741,993. Modern keyboards additionally feature a modulation wheel, which is a second, equal, input control, positioned next to the pitch bend wheel, as depicted in the Moog Minimoog Voyager XL owner's manual. Pitch bend and modulation wheels are advantageous over simple rotary knobs because they can be operated in two modes: one mode where the wheel remains in place when a user releases his or her hand, and one mode where the wheel spins back to its original position when a user releases his or her hand. However, when spinning back, the position to be spun back must be specified beforehand, and is usually the center of the movement position of the wheel, or one end of the wheel's possible movement positions. Also, said pitch bend and modulation wheels can only control one parameter each. While they are easy to reach blindly by users while performing, if manufacturers were to add more wheels, the interface would get cluttered and a user could not find the right wheel easily anymore.

JazzMutant, of Bordeaux, France, had sold a touch controller called Lemur from 2002 to 2010 that focuses on simulating aforementioned haptic controls and offering a flexible layout of said control elements to the user. The user can freely align virtual counterparts of real faders and rotary knobs on the screen. While this allows for a very flexible control layout, the Lemur controller requires users to look at the screen while using it. Furthermore, it requires precise aiming at interface elements because its touch interface does not provide haptic feedback, like traditional faders and knobs do.

Korg, of Tokyo, Japan, has been selling the Korg Kaoss Pad series that provides a single-touch X-Y interface to control audio effects. On the Kaoss Pad series, the user can always control two parameters at a time. Touching the touch area on the bottom left sets both parameters to 0%, and touching it on the top right sets both parameters to 100%. By sliding on the touch area, one can control two parameters individually. The method allows reliable interaction once the user has the finger on the touch area. However, in order to use this method, the user needs to touch the touch area at the right position to start with. This requires the user to look at the touch area before using it. Even when looking at the touch area, it is difficult to find the exact spot where the fingers were released before. On every touch down, the parameter values will jump to the current position, rendering the Kaoss Pad unusable for making fine adjustments to parameters. It is for this reason that by default, the Kaoss Pad effects are reverted when the fingers are released off the touch area.

Moog Music Inc., of Asheville, United States, has added a touch area to some of their Minimoog Voyager synthesizers. The touch area is similar to the Korg Kaoss Pad in that it reacts to X-Y movements in the same way the Kaoss Pad does. In contrast to the Korg Kaoss Pad, the touch area is not encapsulated in a self-contained external hardware effect box, but acts as a control interface to parameters than can also be controlled by other controls on the keyboard, like rotary knobs. In every other aspect, the touch area is similar to the Korg Kaoss Pad and has the same disadvantages regarding fine adjustments of parameters and the need to look at the touch area when putting the fingers on it.

Except for the pitch bend and modulation wheels, all aforementioned methods require the user to look at a control element in order to use it. Furthermore, all aforementioned methods allow users to control only one or two continuous parameters at the same time with one hand and without reaching for a different control.

In conclusion, insofar as I am aware, no control interface formerly developed provides the user an input method that allows him or her to control parameters completely blindly, and that allows him or her to control more than two parameters without switching to a different control element.

### SUMMARY

The various aspects of this invention include a touch surface that detects user input in form of multi-touch gestures to control parameters. The touch surface is not divided in subsections but used as a whole to provide one single area for touch interaction. The touch surface is surrounded by a frame, or a different material than the one used for the touch surface, or an other type of surrounding that prevents the user from accidentially swiping off the touch surface. The presented input method allows a user to control up to ten parameters blindly on a touch area with a single hand. Furthermore, the presented gestures allow a user to alter the sensitivity of the input method while using it.

Accordingly several advantages are to enable users to control parameters without looking at them, to enable the user to control up to ten parameters on a single interface, to enable the user to easily control two parameters at the same time, and to enable the user to make big or fine adjustments to parameters without prior configuration of sensitivity of the input method. Still further advantages will become apparent from a study of the following description and the accompanying drawings.

### DRAWINGS

FIG. 1 is a top-down view on a touch area, illustrating the main touch gesture of the invention.

FIG. 2 is a simplified flowchart of the input control algorithm.

FIG. 3 is an advanced flowchart of the input control algorithm.

FIG. 4 is an advanced flowchart of the input control algorithm that illustrates the handling of a special case that is present in one embodiment.

### DETAILED DESCRIPTION

The various aspects will be described in detail with reference to the accompanying figures. Wherever possible, the same reference numbers will be used throughout the drawings to refer to the same or like parts. References made to particular examples and implementations are for illustrative purposes and are not intended to limit the scope of the invention or the claims.

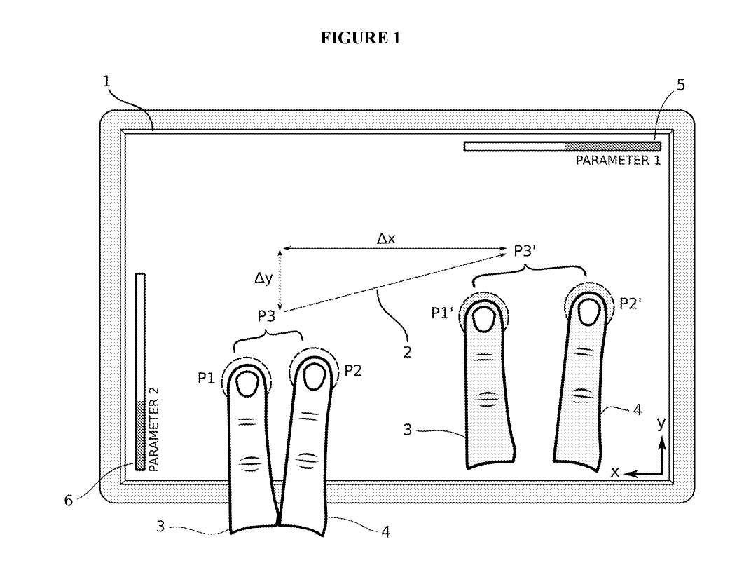

FIG. 1 is a top-down view on a touch area, taken from the user's point of view. It shows a touch area (in further context also described as touch surface, or surface) that is surrounded by a frame. The touch area is not divided into subsections, but acts equally wherever the user touches it. Two fingers 3 and 4 of a user's hand touch the surface at positions P1 and P2. The fingers 3 and 4 move to another position P1′ and P2′. The average positions of P1 and P2, and P1′ and P2′, are illustrated as P3, or P3′ respectively. The movement is illustrated by arrow 2, which points from P3 to P3′. The arrow 2 is divided into two orthogonal components Δx for the horizontal direction and Δy for the vertical direction. Each direction Δx, Δy controls one parameter. The current state of the parameters being controlled by the direction is illustrated in 5 for Δx and 6 for Δy.

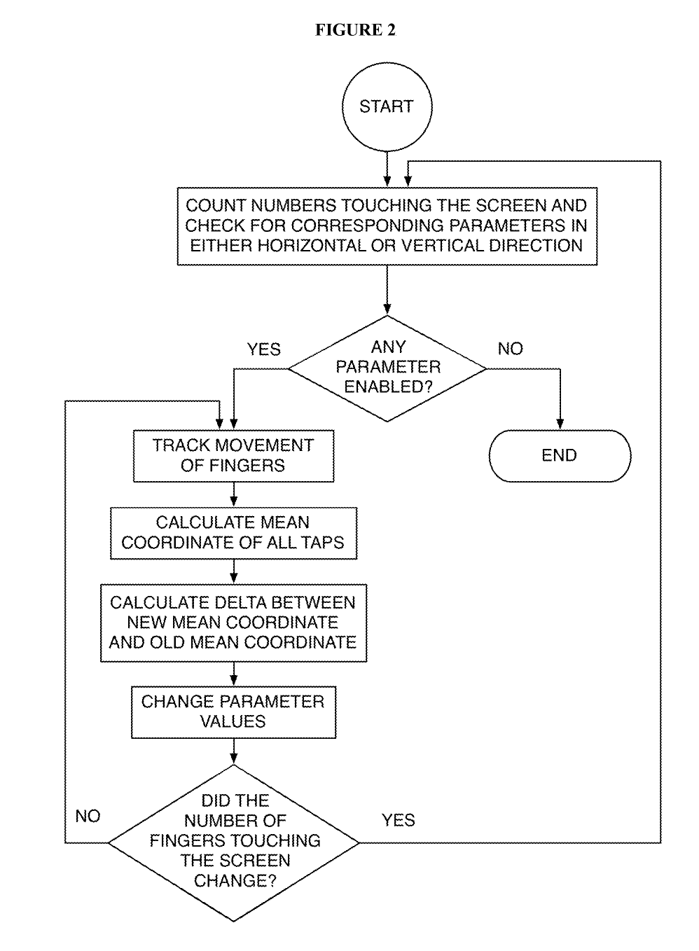

FIG. 1 illustrates the key idea of the invention. First, only the average position P3 and P3′ of the fingers 3 and 4 is important to the user. While moving the fingers, two parameters can be controlled via horizontal and vertical movements Δx, Δy. The absolute position of the fingers 3 and 4 is not important, only the relative movement matters, like on a computer trackpad. By touching the surface with a different number of fingers, the user can control a different pair of parameters. The parameters do not add up; that means that for example, by touching the surface with two fingers, the user does not control the parameters anymore that he or she did control with a single finger. By controlling the interface with one hand, the user can choose between one to five fingers touching the touch area simultaneously, and thus, using both the horizontal and vertical direction, is able to control 10 parameters on a single touch surface. FIG. 2 shows a flowchart that illustrates said basic input algorithm.

The user can control the rate of change in parameter values by moving the fingers quickly or slowly. Because it is harder to swipe with five fingers than it is with one, the system compensates this difficulty by increasing the sensitivity of the touch area with an increasing number of fingers touching the touch area. As a result, the user does not notice a difference in sensitivity between different numbers of fingers at all. A good compensation is to linearly increase the sensitivity to 150% (starting from 100%) for five fingers compared to one, although the perfect compensation depends on the size and positioning of the touch area being used.

Because described algorithm uses only the average distance of the fingers, the user can change the sensitivity of the touch surface when he or she is touching the touch area with two or more fingers. By moving not all, but only a few of the fingers that touch the touch area, the system will calculate a smaller distance 2. FIG. 1 shows an example where the user touches the touch surface with two fingers 3 and 4. If he or she only moved finger 4, then P1 and P1′ would be the same, and thus P3′−P3 would be ½*(P2′−P2). Thus, the distance 2 is only half as large compared to the case where the user moved both fingers 3 and 4 equally far. This way, the user can adjust the sensitivity of the touch surface directly while controlling it. This is a major improvement over current touch areas, modulation wheels or haptic controls where the user has to decide on a certain amount of sensitivity up front.

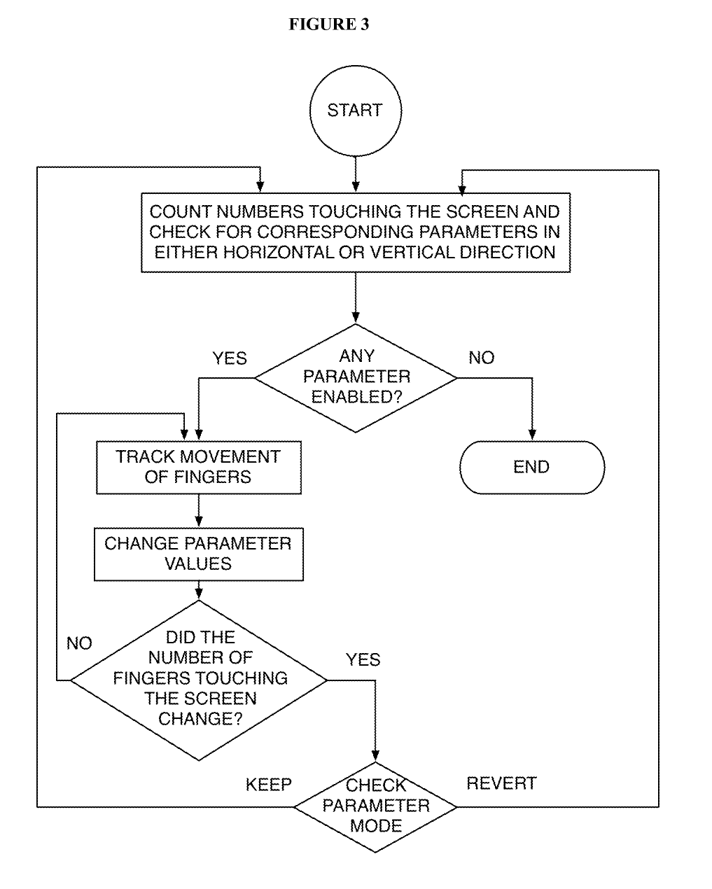

The disclosed invention also allows the user to choose between making Permanent or Temporary changes to a parameter value. A Permanent change happens when the user releases his or her fingers from the touch area and the newly assigned value is kept. A Temporary change, on the other hand, is being reverted when the user releases his or her fingers from the touch area. The value it is being reverted to is the value of the state when the user started his or her movement. The system not only decides whether to revert or keep a value when lifting fingers off the surface, but also at any time the number of fingers touching the surface, and therefore the set of parameters being controlled, changes. This behavior is illustrated in a flowchart in FIG. 3.

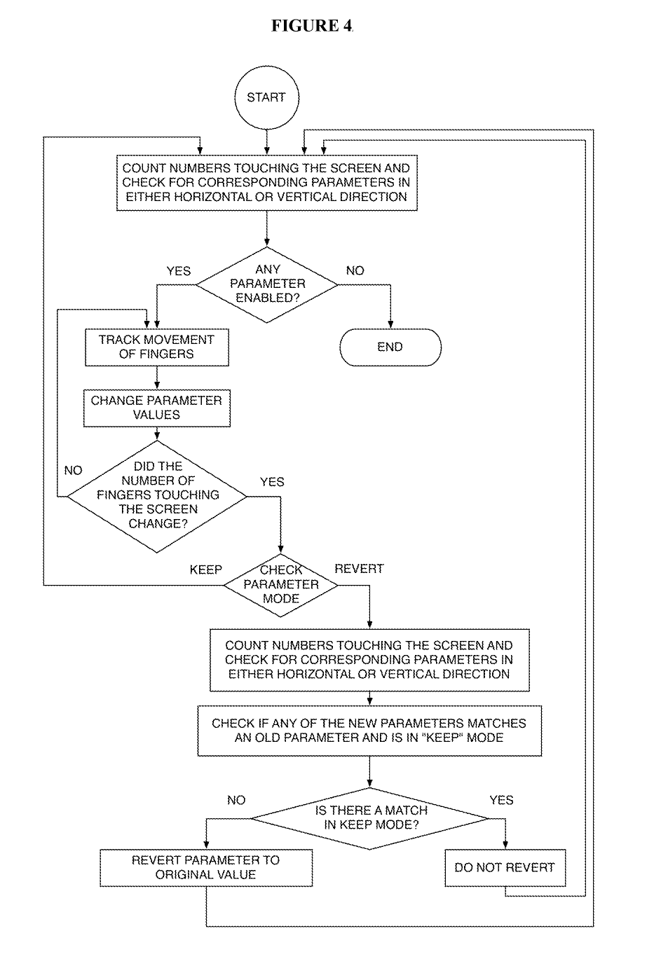

In one embodiment, there is a special case where the system does not revert a Temporary parameter. If the user changes the number of fingers he or she touches the touch area with, and the parameter to be reverted is being controlled by the new number of fingers, too, and the behavior of this parameter under the new number of fingers touching the touch area is set to Permanent, then the value will not get reverted. This behavior is illustrated in a flowchart in FIG. 4.

In other embodiments, the system only reverts values when all fingers are lifted off the surface, or, in another embodiment, when a certain transition between fingers touching the screen is made. This way, parameter changes can be constructed one by one and then all together be reverted at one time.

Because of the behavior of temporary parameters disclosed in the previous two paragraphs and illustrated in FIG. 3 and FIG. 4, it is extremely important that the system reliably recognizes the correct number of fingers touching the touch surface. When swiping over the surface, users may accidentally lift a finger off the touch area for a really short period of time, or the touch area used may not always recognize the correct numbers of fingers. Also, when starting to touch the touch area with multiple fingers at the same time, some fingers might reach the touch area slightly before others, for example when the hand is tilted. Therefore the system implements a small delay in processing touch-up and touch-down events, where a touch-up event happens when a finger is lifted off the touch area, and a touch-down event happens when a finger starts to touch the touch area. A good value for said delay is about 30 ms, although the exact value depends on the touch area used. When the system recognizes a touch-up or touch-down event, it will wait for specified delay time before it processes it. Only if during this time, no further touch-down or touch-up event has happened, the system will treat the touch-up or touch-down event as intended by the user. If a touch-down or touch-up event is recorded during the delay time period, the delay time starts from 0 again. The delay time has to be long enough to make the system not react to accidental events, but has to be short enough so that the user does not notice that there is a delay in processing of his or her taps.

With the help of another gesture, the disclosed system allows the user to control not just two, but four parameters at the same time. All four parameters have to be permanent, not temporary (see above for definition). By swiping with a certain number n of fingers and then continuously tapping with another finger, the system will alternately increase the two parameters assigned said certain number n of fingers and the two parameters assigned to n+1 fingers. This will work very well if the delay time discussed in the previous paragraph is chosen correctly. In consequence, this powerful input gesture serves as a good measure for selecting the correct delay time.

The disclosed system allows the user to freely assign which parameters are being controlled. There are numerous ways to configure this. One embodiment contains a touch screen with a user interface for configuring the parameters. For each combination of direction and number of fingers touching the screen, the user interface allows the user to select one parameter that is being controlled by said combination. The exact specification of the method to configure the parameter mapping is not part of this patent. In one embodiment, it is also possible that the mapping is fixed and the user cannot change it. For the scope of disclosed invention, it is only important that the invention includes the possibility for the user to freely select what he or she controls with his or her swipe gestures, making this invention a very flexible tool.

It the embodiment uses a touch screen to configure the parameter mappings, and the touch area of the screen is the same as the touch area used for the input method in FIG. 1, then there must be a way for the user to toggle between the configuration screen and the screen of FIG. 1. It is part of the invention that the user cannot accidentally leave the screen of FIG. 1 just by performing the gestures used to control parameters. To switch to the configuration screen, the user either uses an external input device, like a button next to the screen, or the user performs a new gesture. One example for such a new gesture would be double-tapping in the corner of a screen.

### CONCLUSION, RAMIFICATIONS, AND SCOPE

Accordingly, the reader will see that the multi-touch interface of the various embodiments can be used to control multiple parameters easily, and blindly, with a single hand in a real-time situation. In addition, the user can alter the sensitivity of the interface easily while performing, allowing both subtle and dramatic changes to a parameter, and rendering it unnecessary to choose a specific sensitivity beforehand. Furthermore, said multi-touch interface has the additional advantages in that:
it combines the advantages of pitch-bend and modulation wheels over other input methods like faders in that it can revert Temporary parameters to their original values after the user is done controlling parameters (various embodiments are proposed to demonstrate use cases of when a user can be done controlling parameters).
it can use any arbitrary original value (in contrast to said wheels), and is not mechanically constrained to, for example, a original value of 50%, which would be proportional to a centered wheel position.
it can integrate with other parameter control methods, because the changes to parameters are always relative;
due to said relative behavior, it does not create surprising parameter value jumps when being used after a parameter was changed on the device, e.g. via a a preset change (a preset being a saved state of parameter values);
many embodiments can be combined into a single, configurable embodiment, if the invention is combined with a means to select a behavior, making the invention very versatile; and
if the invention is built right into a device—for example, a musical keyboard—and the invention is built using a touch screen, said touch screen can replace the existing display of that device and integrate the old display's functionality in the invention's screen, thus saving valuable space on the interface of the device.

Although the description above contains many specifities, these should not be construed as limiting the scope of the embodiments but as merely providing illustrations of some of several embodiments. For example, the touch screen can have other shapes, and screen and touch surface can be separated, or the screen can be omitted and the touch area can be combined with buttons and LED indicators instead, or the frame of the device can be omitted by constructing a touch area that goes edge-to-edge, therefore haptically notifying the user when he or she is leaving the touch area, etc.

Thus the scope of the embodiments should be determined by the appended claims and their legal equivalents, rather than by the examples given.

1. A multi-touch interface that allows users to change multiple parameters blindly, comprising:
providing a multi-touch surface that interacts coherently over its whole area,
interpreting the vertical and horizontal movement of a variable number of fingers on said multi-touch area to control said parameters, one via the horizontal and one via the vertical direction,
enabling the user to control two parameters at the same time via said horizontal and vertical movements without requiring the user to look at the touch surface,
changing the parameters to be controlled by said touch-area movement by altering the number of fingers that touch said touch-area without requiring the user to look at the touch surface,
allowing a user to control the sensitivity of said multi-touch interface via the movement of his or her fingers while at the same time controlling said parameters,
giving some sort of haptic feedback when the user reaches the end of the touch surface,
detecting the correct number of fingers on the touch area by implementing a fault-tolerance delay of about 30 ms to ignore accidental taps
enabling the user to control four parameters at the same time by quickly alternating between two different numbers of fingers touching the touch area while swiping diagonally across the touch surface
providing a method to configure the parameters that can be controlled by each combination of numbers of fingers and touch gesture,
providing a method that makes sure the user does not accidentally alter a gesture-parameter mapping and thereby modify the device's behavior while the user is interacting with the device to control said parameters.
